(19) United States
(12) Patent Application Publication
(10) Pub. No.: US 2026/0244642 A1
(43) Pub. Date: Aug. 20, 2026

(54) FULL SPECTRUM METADATA REPLICATION AND RESTORATION

(71) Applicant: State Farm Mutual Automobile Insurance Company, Bloomington, IL (US)

(72) Inventor: Suchitra Duvvuri, Bloomington, IL (US)

(21) Appl. No.: 19/057,232

(22) Filed: Feb. 19, 2025

(51) Int. Cl. G06F 16/27; G06F 16/22

(52) U.S. Cl. CPC G06F 16/27; G06F 16/2282

(57) ABSTRACT

Described herein are systems and techniques to facilitate rapid and effective replication of a data processing system using granular metadata, including metadata representing table-level permissions and data filters. Metadata is determined and stored in a metadata processing system that accounts for table-level and other low-level configurations. This data is then used to replicate some or all of a data processing system. Data stored by data assets may also be replicated, or the metadata may be used to replicate some or all of the functionality of the data processing system for processing other data.

### BACKGROUND

The increase in computer network capacity and quality has led to an exponential growth in the use of remote and decentralized data processing and storage systems, often referred to as “cloud” systems. Many types of organizations and users interact with cloud data processing and storage systems and other types of data processing systems to perform a variety of operations. For example, data processing systems are routinely used for sales transactions, financial transactions, customer service interactions, social media interactions, providing entertainment content, controlling equipment and infrastructure, and storing any data related to such functions.

The use of cloud-based data processing systems allows customers of such systems to provide services and host applications without incurring the expense of purchasing and maintaining physical equipment. These data processing systems may include many virtual and/or physical assets of various types with complex configurations. The configurations of the assets in a data processing system may be represented in metadata. While current systems may allow for the granular configuration of various aspects of data assets in a data processing system, currently, not all such configurations are captured and/or available for replication as metadata. The examples of the present disclosure are directed to overcoming these deficiencies and providing a faster and more efficient means of replicating some or all of the functionality provided by a data processing system implemented as a cloud-based system.

### SUMMARY

Techniques described herein implement a full spectrum replication and restoration system that facilitates rapid and effective replication of a data processing system using granular metadata, including metadata representing table-level permissions and data filters. Metadata is determined and stored in a metadata processing system that accounts for table-level and other low-level configurations. This data is then used to replicate some or all of a data processing system. Data stored by data assets may also be replicated. Alternatively, the metadata may be used to replicate some or all of the functionality of the data processing system for processing other data.

For example, the techniques described herein may relate to a computer-implemented method of replicating a data processing system using metadata, the computer-implemented method comprising detecting, by a processor, a data processing system replication condition; in response to detecting the data processing system replication condition, determining, by the processor, a metadata replication data structure; determining, by the processor and based at least in part on the metadata replication data structure, data asset metadata for a first data asset; determining, by the processors and based at least in part on the data asset metadata, a data asset type of the first data asset; determining, by the processor and based at least in part on the data asset metadata, table metadata for a first database table associated with the first data asset; transmitting, by the processor, to a remote computing system via an application programming interface (API), a request to instantiate a second data asset; transmitting, by the processor, to the remote computing system via the API, and based at least in part on the table metadata, a request to generate a second database table at the second data asset; and transmitting, by the processor, to the remote computing system via the API, and based at least in part on the table metadata, a request to configure the second database table at the second data asset with one or more of a table permission or a table data filter represented in the table metadata.

In examples, the request to configure the second database table is a request to configure the second database table with the table permission, the table permission comprises a role permission, and the role permission comprises one or more of a column role permission or a row role permission. In examples, the request to configure the second database table is a request to configure the second database table with the table data filter, the table data filter comprises a user data filter, and the user data filter comprises one or more of a column user data filter or a row user data filter. Detecting the data processing system replication condition may include receiving an instruction from a computing device to initiate a replication of the data processing system. The instruction may include one or more replication parameters comprising one or more of an indication of the remote computing system or a subset of the metadata replication data structure. In examples, a request may be transmitted to the remote computing system via the API to configure the second database table at the second data asset with data associated with the first data asset. In examples, the metadata replication data structure comprises historical metadata.

The techniques described herein may also relate to a non-transitory computer-readable medium comprising instructions that, when executed by one or more processors, cause the one or more processors to replicate a data processing system using metadata by performing operations comprising determining a metadata replication data structure; determining, based at least in part on the metadata replication data structure, data asset metadata for a first data asset; determining, based at least in part on the data asset metadata, a data asset type of the first data asset; determining, based at least in part on the data asset metadata, table metadata for a first database table associated with the first data asset; transmitting, to a remote computing system via an application programming interface (API), a request to instantiate a second data asset; transmitting, to the remote computing system via the API and based at least in part on the table metadata, a request to generate a second database table at the second data asset; and transmitting to the remote computing system via the API and based at least in part on the table metadata, a request to configure the second database table at the second data asset with one or more of a table permission or a table data filter represented in the table metadata.

In examples, the request to configure the second database table is a request to configure the second database table with the table permission, the table permission comprises a user permission, and the user permission comprises one or more of a column user permission or a row user permission. In other examples, the request to configure the second database table is a request to configure the second database table with the table data filter, the table data filter comprises a role data filter, and the role data filter comprises one or more of a column role data filter or a row role data filter. Detecting the data processing system replication condition can include receiving an instruction from a computing device to initiate a replication of the data processing system. The instruction may include one or more replication parameters comprising one or more of an indication of the remote computing system or a subset of the metadata replication data structure. In examples, the subset of the metadata replication data structure includes data representing the second database table at the second data asset. The first data asset may be configured at a first cloud-based platform and the second data asset is configured at a second cloud-based platform distinct from the first cloud-based platform.

The techniques described herein may also relate to a system for replicating a data processing system using metadata, the system including one or more processors; and a non-transitory memory storing computer-executable instructions that, when executed, cause the one or more processors to perform operations comprising determining a metadata replication data structure; determining, based at least in part on the metadata replication data structure, data asset metadata for a first data asset; determining, based at least in part on the data asset metadata, a data asset type of the first data asset; determining, based at least in part on the data asset metadata, table metadata for a first database table associated with the first data asset; transmitting, to a remote computing system via an application programming interface (API), a request to instantiate a second data asset; transmitting, to the remote computing system via the API and based at least in part on the table metadata, a request to generate a second database table at the second data asset; and transmitting to the remote computing system via the API and based at least in part on the table metadata, a request to configure the second database table at the second data asset with one or more of a table permission or a table data filter represented in the table metadata.

In examples, detecting the data processing system replication condition includes receiving an instruction from a computing device to initiate a replication of the data processing system. The instruction may include one or more replication parameters comprising one or more of an indication of the remote computing system or a subset of the metadata replication data structure. In examples, the request to configure the second database table is a request to configure the second database table with the table data filter, the table data filter comprises a role data filter, and the role data filter comprises one or more of a column role data filter or a row role data filter. In examples, the request to configure the second database table is a request to configure the second database table with the table permission, the table permission comprises a user permission, and the user permission comprises one or more of a column user permission or a row user permission.

The techniques described herein may also relate to a system for replicate a data processing system using metadata, the system comprising means for determining a metadata replication data structure; means for determining, based at least in part on the metadata replication data structure, data asset metadata for a first data asset; means for determining, based at least in part on the data asset metadata, a data asset type of the first data asset; means for determining, based at least in part on the data asset metadata, table metadata for a first database table associated with the first data asset; means for transmitting, to a remote computing system via an application programming interface (API), a request to instantiate a second data asset; means for transmitting, to the remote computing system via the API and based at least in part on the table metadata, a request to generate a second database table at the second data asset; and means for transmitting to the remote computing system via the API and based at least in part on the table metadata, a request to configure the second database table at the second data asset with one or more of a table permission or a table data filter represented in the table metadata.

### BRIEF DESCRIPTION OF THE DRAWINGS

FIG. 1 illustrates an example environment in which full spectrum metadata replication and/or restoration systems and techniques may be implemented according to examples described herein.

FIG. 2 is an example metadata replication data structure that may be used in full spectrum metadata replication and restoration systems and techniques according to the examples described herein.

FIG. 3 is a flow diagram illustrating an example process for generating a full spectrum metadata data structure for use in full spectrum metadata replication and restoration systems and techniques according to the examples described herein.

FIG. 4 is a flow diagram illustrating an example process for generating a full spectrum table metadata data structure for use in full spectrum metadata replication and restoration systems and techniques according to the examples described herein.

FIG. 5 is a flow diagram illustrating an example process for replicating a data processing system in full spectrum metadata replication and restoration systems and techniques according to the examples described herein.

FIG. 6 illustrates an example system architecture for a computing device that may be used to implement the systems and architectures described herein.

The detailed description is set forth with reference to the accompanying figures. In the figures, the left-most digit(s) of a reference number identifies the figure in which the reference number first appears. The use of the same reference numbers in different figures indicates similar or identical items.

### DETAILED DESCRIPTION

Certain implementations and examples of the disclosure will now be described more fully below with reference to the accompanying figures, in which various aspects are shown. However, the various aspects may be implemented in many different forms and should not be construed as limited to the implementations set forth herein. The disclosure encompasses variations of the examples, as described herein. Like numbers refer to like elements throughout.

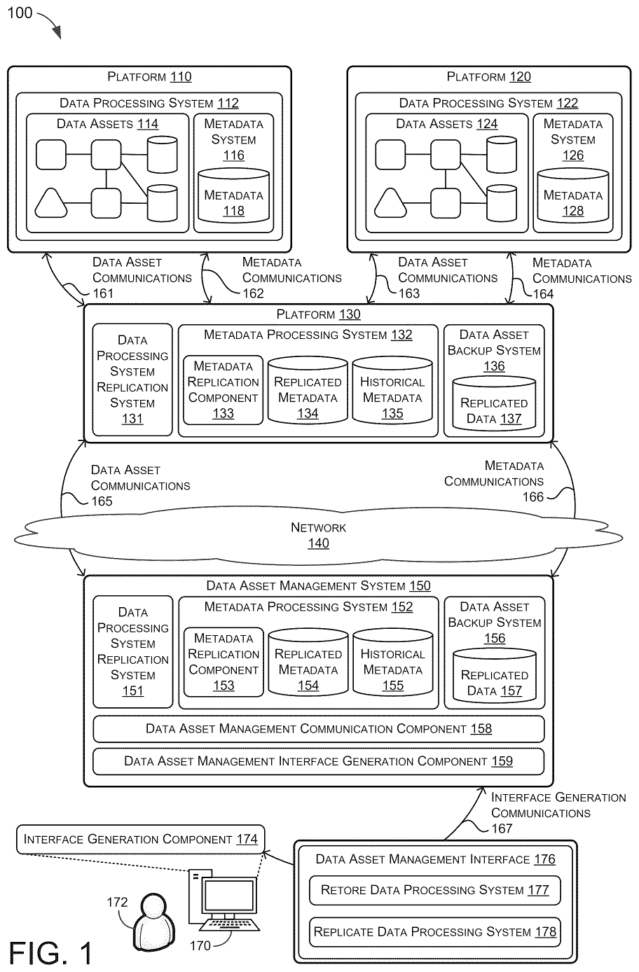

FIG. 1 illustrates an environment 100 in which a full spectrum metadata replication and restoration framework may be implemented according to examples of the instant disclosure. A platform 110 may be configured in the environment 100 that may provide various services to remote customers or operators. For example, the platform 110 may be provided by a cloud service provider or any other provider that provides computing resources (e.g., hardware, software, and/or network resources) for executing and providing access to customer services. As used herein, a “service” may be any one or more applications executed on a remote (e.g., with respect to the customer associated with the service) platform. A “platform,” as used herein, may be any combination of hardware, software, and other computing resources to which a customer may have limited access for the purposes of configuring and executing one or more services. Such services may be implemented across any number, type, and combination of computing resources represented as the platform(s) 110. The platform(s) 110 may be distributed across any number of geographical and physical locations and may represent any type and quantity of physical and/or logical (e.g., virtual machines) computing resources that may be used to support one or more services.

For example, the platform 110 may support a data processing system 112 that may be configured to provide one or more services on behalf of a customer or other user. The data processing system 112 may be implemented using a variety of data assets 114. The data assets 114 may include one or more physical or virtual computing resources, such as one or more databases, database tables, processing resources, data storage resources, network resources, etc. The configurations that allow a set of data assets to interoperate and execute functions of a data processing system may be represented as metadata. In examples, a metadata system 116 may determine (e.g., collect, retrieve, etc.) metadata 118 that may represent the configurations of the data assets 114. As used herein, a “data asset” may include an individual database table asset or any other individual data structure.

It may be desirable or necessary to replicate a data processing system. For example, if the data processing system 112 becomes unavailable for some reason (e.g., platform outage, network connectivity issue, etc.), the operator of the data processing system 112 may desire to duplicate the data assets 114 in the configuration represented by the metadata 118 on another platform, such as a platform 120. In some examples, the operator may replicate the data processing system 112 in advance in preparation for any outages that may occur, while in other examples, the operator may replicate the data processing system as needed when an actual outage occurs.

An operator may wish to replicate some or all of a data processing system for other reasons. For example, the operator of the data processing system 112 may wish to establish another data processing system in another region or on another platform to perform functions similar to those performed by the data processing system 112. In such examples, the operation may wish to replicate the data processing system 112 in its entirety, but not necessarily the data stored at the data processing system 112 (e.g., because this new data processing system may be performing similar functions but for different customers and/or users). In other examples, the operator of the data processing system 112 may wish to replicate portions of the data processing system 112 rather than the entire data processing system 112. For instance, the operator may wish to replicate one or more databases (or the configurations of such databases) in another environment or platform. Similarly, the operator may wish to replicate one or more database tables (or the configurations of such tables) in another environment or platform.

In particular, an operator may wish to replicate, in another data processing system, lower-level configurations that are not readily captured and replicated in conventional systems and techniques. Modern platforms that provide computing resources to customers and users (“operators”) to implement data processing systems may allow very fine-grained configuration of data assets in such data processing systems. For example, a database asset may be configured by an operator with various data filters that limit the data that may be extracted from the database. In particular examples, a database table asset may be configured by an operator with various data filters that limit the data that may be extracted from the database table. Such filters and other data access control means may be configured at a table level, allowing control of data extraction from particular tables. Such filters may even be configured at column and row levels, allowing even more granular control of data extraction from particular columns and/or rows. Similarly, a database asset may be configured by an operator with various permissions that limit access to a database and/or other data asset. In particular examples, a database table asset may be configured by an operator with various permissions that limit the data that may be extracted from the database table. These permissions may be individual user permissions and/or permissions associated with one or more roles (e.g., sets of permissions that may be assigned to individual users). Like data filters, such permissions may be configured at a table level, allowing control of the users that are permitted to perform data extraction from particular tables. Such permissions may even be configured at column and row levels, allowing even more granular control of the users that are permitted to perform data extraction from particular columns and/or rows. Other highly granular configurations may be applied to a variety of data assets that may be included in a data processing system.

Because conventional systems and techniques do not provide a means of capturing and/or replicating such granular configurations in data assets, replicating a data processing system, or a subset of such a system, may be very challenging. Manual configuration may be needed to implement the more granular and/or lower-level configurations in a replicated system that are not readily automated by current technology. The disclosed systems and techniques provide a means of duplicating the full spectrum of configurations that may be used to implement a data processing system with a variety of data assets, greatly improving the efficiency of system replication processes and reducing the time required to replicate a data processing system.

Referring again to FIG. 1, in examples, a metadata processing system 132 may be implemented at a platform 130 that may perform one or more operations to collect and process metadata to, for example, replicate all or a portion of a data processing system. The platform 130 may be the same platform as the platform 110 or a distinct platform. Like platform 110, platform 130 may provide computing resources and/or services to customers and/or users (operators).

The metadata processing system 132 may include a metadata replication component 133 that may be configured to obtain, access, and/or otherwise determine metadata associated with a data processing system, such as the data processing system 112. This metadata may represent the configurations used to implement the data processing system 112 and/or otherwise facilitate the operation of the data processing system 112 and its interoperation with other systems and/or users (as opposed to the actual data stored and/or processed at the data processing system 112). Such configuration data may include data filters, permissions, roles, users, other control mechanisms, etc. and the particular assets and/or other components with which such data access control means may be associated. In examples, the metadata replication component 133 may exchange metadata communications 162 with the data processing system 112, and, in some examples, specifically with the metadata systems 116, to obtain the metadata 118 that may represent the various configurations of the data assets 114. The metadata communications 162 may be any form of communications exchanged between computing devices, including communications via one or more application programming interfaces (APIs). The metadata replication component 133 may store this determined metadata as replicated metadata 134. The metadata replication component 133 may also, or instead, store this determined metadata in historical metadata 135 that may maintain a record of metadata over time. If a roll-back to a previous configuration for a data processing system is desirable, the system may retrieve a historical version of the metadata that may be used to configure a data processing system.

The platform 130 may further include a data asset backup system 136 that may store replicated data 137. As opposed to the replicated metadata 134, the replicated data 137 may be the data actually stored by the data assets 114. In examples, the data asset backup system 136 may exchange data asset communications 161 with the data processing system 112, and, in some examples, specifically with the data assets 114, to obtain the replicated data 137 that may represent the data stored by the data assets 114. The data asset communications 161 may be any form of communications exchanged between computing devices, including communications via one or more APIs.

The platform 130 may further include a data processing system replication system 131 that may be configured to initiate and/or otherwise perform operations to replicate, in whole or in part, a data processing system. For example, in response to one or more conditions (e.g., detection of an outage, receipt of a user instruction, network latency above a threshold value, etc.), the data processing system replication system 131 may determine the data processing system to be replicated, the extent of such replication, and the destination platform for the replicated data processing system. In other examples, the data processing system replication system 131 may perform replication operations as described herein on based on a schedule (e.g., monthly, weekly, daily, etc.) and/or stored configurations.

For example, the data processing system replication system 131 may determine that the data processing system 112 is to be replicated at the platform 120 based on receiving a command from a user that indicates the data processing system 112, the destination platform 120, the timing of the replication, the extent of the replication, and/or other replication parameters. Alternatively or additionally, the data processing system replication system 131 may be configured with such replication parameters and may initiate replication operations based on these parameters in response to detecting a condition, such as an outage, increased latency, etc. In examples, the platform 120 may be a platform similar to either of the platform 110 or the platform 130, while in other examples the platform 120 may be the same platform as the platform 110 and/or the platform 130.

Using the replication parameters, the data processing system replication system 131 may request, via data asset communications 163, that data assets 124, which may be similar to the data assets 114, be instantiated at the platform 120. In examples where the extent of the replication of the data processing system 112 includes replication of the data stored at the data assets 114, the data processing system replication system 131 may also request, via data asset communications 163, that replicated data 137 be stored at the data assets 124 corresponding to data assets 114 on which such data originated. The data asset communications 163 may be any form of communications exchanged between computing devices, including communications via one or more APIs.

The data processing system replication system 131 may further cause the metadata processing system 132 to retrieve and transmit, via metadata communications 164, the replicated metadata 134 to the platform 120 and, specifically, in some examples, to a metadata system 126 for storage as metadata 128. The metadata system 126 may perform, in a replicated data processing system 122, similar functions as the metadata system 116. The metadata communications 164 may be any form of communications exchanged between computing devices, including communications via one or more APIs.

The systems configured at the platform 130 may be operated, configured, and/or otherwise controlled by a data asset management system 150. The data asset management system 150 may communicate with the platform 110, the platform 120, and/or the platform 130 via the network 140. The network 140 may be any one or more wireless and/or wired networks that may be configured to facilitate communications between computing devices and/or functions. The network 140 may represent any communications means (e.g., any physical and/or logical communications connections) that allow data asset management system 150 to interact with other components in such a cloud-based system, such as the platform 110, the platform 120, and/or the platform 130.

The data asset management system 150 may include a data processing system replication system 151 that may be configured, similar to the data processing system replication system 131, to initiate and/or otherwise perform operations to replicate, in whole or in part, a data processing system. For example, in response to one or more conditions (e.g., detection of an outage, receipt of a user instruction, network latency above a threshold value, etc.), the data processing system replication system 151 may determine the data processing system to be replicated, the extent of such replication, and the destination platform for the replicated data processing system. Alternatively or additionally, the data processing system replication system 151 may generate and provide instructions to the data processing system replication system 131 to perform one or more replication operations as described herein.

In examples, the data asset management system 150 may include a data asset management communication component 158 that may facilitate communications with one or more other systems. For example, the data asset management communication component 158 may generate and exchange data asset communications 165 with the platform 130 and, in examples, specifically with the data processing system replication system 131. The data asset communications 165 may include instructions and other data that may cause a replication of the data assets of a data processing system, such as the data processing system 112 (e.g., via the data processing system replication system 131). The data asset communications 165 may be any form of communications exchanged between computing devices, including communications via one or more APIs.

The data asset management communication component 158 may also, or instead, generate and exchange metadata communications 166 with the platform 130 and, in examples, specifically with the data processing system replication system 131. The metadata communications 166 may include instructions and other data that may cause a replication of the metadata of a data processing system, such as the data processing system 112 (e.g., via the data processing system replication system 131). The metadata communications 166 may be any form of communications exchanged between computing devices, including communications via one or more APIs.

In some examples, the data asset management system 150 may obtain and maintain replication metadata, replicated data, and other data that may facilitate the replication of a data processing in a manner similar to that described above in regard to platform 130. This may allow more “local” control of replication processes where the data asset management system 150 is locally maintained and/or otherwise not implemented on one or more of the platforms 110, 120, and 130.

As noted, the data asset management system 150 may include the data processing system replication system 151 that may perform any or all of the functions performed by the data processing system replication system 131. The data asset management system 150 may further include a metadata processing system 152 that may perform one or more operations to collect and process metadata to, for example, replicate all or a portion of a data processing system. The metadata processing system 152 may perform any or all of the functions performed by the metadata processing system 132. For example, the metadata processing system 152 may include a metadata replication component 153 that may be configured to obtain, access, and/or otherwise determine metadata associated with a data processing system, such as the data processing system 112.

In examples, the metadata replication component 153 may exchange metadata communications 166 with the platform 130 that may, in turn, exchange metadata communications 162 with the data processing system 112 and/or metadata communications 164 with the data processing system 122 (in examples, specifically with the metadata systems 116 and/or the metadata systems 126, respectfully). Such communications may allow the metadata replication component 153 to obtain the metadata 118 that may represent the various configurations of the data assets 114. Such communications may also, or instead, allow the metadata replication component 153 to obtain the metadata 128 that may represent the various configurations of the data assets 124. The metadata replication component 153 may store this determined metadata as replicated metadata 154. The metadata replication component 153 may also, or instead, store this determined metadata in historical metadata 155 that may maintain a record of metadata over time for use if a rollback to a previous configuration for a data processing system is desirable.

The data asset management system 150 may further include a data asset backup system 156 that may be similar to the data asset backup system 136 and that may store replicated data 157. The replicated data 157 may be data stored by the data assets 114 and/or the data assets 124 and may be obtained or accessed by the data asset management system 150 and/or the data asset backup system 156 via a data asset communications data asset communications 163, and/or data asset communications 165.

The data asset management system 150 may also, or instead, include a data asset management interface generation component 159 that may be configured to generate interfaces that can be presented to a user. For instance, a user 172 may be operating a computing system 170 that may be hosting or otherwise interacting with the data asset management system 150. The data asset management interface generation component 159 may interact with an interface generation component 174 of the computing system 170. For example, the data asset management interface generation component 159 may receive, obtain, generate, and/or determine data associated with one or more replication operations and/or activities performed as described herein. The data asset management interface generation component 159 may receive a request for such data and/or may otherwise determine to provide such data to the interface generation component 174. The interface generation component 174 may then use such data to generate and present (e.g., on a device display) a visual representation of data processing system replication data and/or one or more controls to facilitate data processing system replication operations.

For instance, the interface generation component 174 may generate, in response to exchanging interface generation communication 167 with the data asset management interface generation component 159, a data asset management interface 176 that may allow the user 172 to interact with, execute, initiate, or otherwise manipulate data processing system replication operations and data via interface elements presented on the data asset management interface 176. For example, the data asset management interface 176 may include a restore data processing system control 177 that may initiate a (e.g., complete or full) replication of a data processing system upon activation by a user. The data asset management interface 176 may also, or instead, include a replicate data processing system control 178 that may initiate a (e.g., complete, full, partial, etc.) replication of a data processing system's data assets and configuration (e.g., replicating some or all metadata without restoring data stored at data assets of the origin data processing system) upon activation by a user.

The interface generation component 174 configured at the computing system 170 may be an application and/or service that is configured to communicate with the data asset management system 150, the platform 110, the platform 120, and/or the platform 130 and to generate and/or present interfaces on the computing system 170. In some examples, the interface generation component 174 may be a browser application. The interface generation component 174 may have associated states and data that may be used in the generation of interfaces as described herein.

By collecting and processing metadata representing a data processing system configuration data for automatically generating and replicating data processing systems, the systems and techniques described herein facilitate the faster and more efficient implementation of replacement systems and supplemental systems as needed, and therefore speedier resolution to outages and other user-impacting events. Moreover, the disclosed full spectrum metadata replication and restoration techniques enable high granularity replication of data processing systems while reducing or eliminating manual operations, thereby allowing rapid deployment of needed services. For example, the disclosed systems and techniques provide a faster and more efficient way to configure a data processing system based on an existing system compared to traditional techniques of using human operators to determine and manually configure lower-level configurations for data assets in a data processing system.

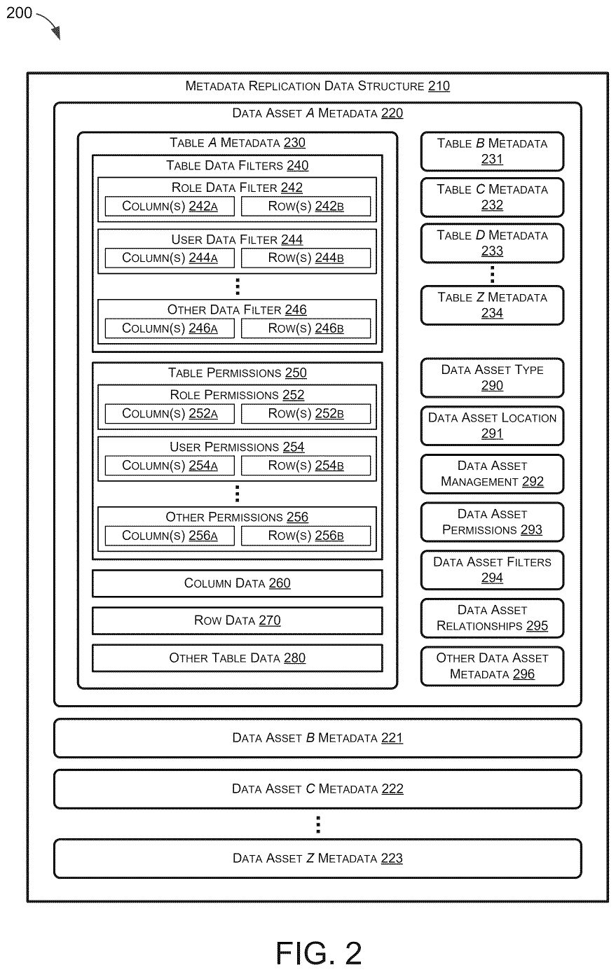

FIG. 2 illustrates a diagram 200, representing an exemplary metadata replication data structure 210. The exemplary metadata replication data structure 210 may be used to represent metadata associated with a data processing system, such as one or more of the data processing system 112 and the data processing system 122 of FIG. 1. For instance, data structures such as the exemplary metadata replication data structure 210 may be used to represent metadata at the metadata 118, the metadata 128, the replicated metadata 134, the historical metadata 135, the replicated metadata 154, and/or the historical metadata 155 of FIG. 1.

The metadata replication data structure 210 illustrates the finer granularity that may be provided by the disclosed full spectrum metadata replication and restoration systems and techniques. The metadata replication data structure 210 may include metadata for one or more data assets (e.g., one or more databases, database tables, etc.), such as data asset A metadata 220, data asset B metadata 221, data asset C metadata 222 . . . data asset Z metadata 223. The metadata 220-223 represents any quantity and type of metadata for any number and type of data assets.

For example, data asset A metadata 220 may include metadata for a database, which may include metadata for one or more database tables associated with that database. For instance, the data asset A metadata 220 may include table A metadata 230, table B metadata 231, table C metadata 232, table D metadata 233 . . . table Z metadata 234. The metadata 230-224 represents any quantity and type of metadata for any number and type of database tables.

Other data associated with the database may be represented in the data asset A metadata 220. For example, the data asset A metadata 220 may include data representing a data asset type 290, a data asset location 291, a data asset management type 292, one or more data asset permissions 293, one or more data asset filters 294, one or more data asset relationships 295 (e.g., defining interconnectedness and communication with one or more other data assets), and any other data asset metadata 296.

Included within table metadata may be general database table configuration information as well as granular configuration information. For instance, the table A metadata 230 may include column data 260 that may define column attributes and configurations for the table A and row data 270 that may define row attributes and configurations for the table A. Other table configuration data may be represented in metadata 230 as other table data 280.

Among the granular configurations that may be represented in metadata according to the disclosed examples is table-level data filters, which are not available as replicable metadata in conventional systems. For example, the table A metadata 230 may include table data filters 240. These filters may limit the data that may be extracted from the table A. The table data filters 240 may be generally applicable to all data extractable from the table A and/or may be further granularly applied. For instance, the table data filters 240 may include one or more role data filters 242 that may limit the data that may be extracted from the table A based on a role assigned to a user attempting to extract such data. The role data filters 242 may even more granularly limit the data that may be extracted from the table A based on one or more columns 242a (“column role data filter”) and/or one or more rows 242b (“row role data filter”) for a particular role assigned to a user attempting to extract such data. For instance, such filters may limit or block access for a particular role (specified in the role data filter 242) to a set of one or more columns (specified in the columns 242a) and a set of one or more rows (specified in the rows 242b).

The table data filters 240 may include one or more user data filters 244 that may limit the data that may be extracted from the table A based on a user attempting to extract such data. The user data filters 244 may even more granularly limit the data that may be extracted from the table A based on one or more columns 244a (“column user data filter”) and/or one or more rows 244b (“row user data filter”) for a particular user attempting to extract such data. For instance, such filters may limit or block access for a particular user (specified in the user data filters 244) to a set of one or more columns (specified in the columns 244a) and a set of one or more rows (specified in the rows 244b).

Any other filter criteria may be used as a basis for table data filters, represented as other data filters 246, and any such filters may further granularly limit the data that may be extracted from the table A based on columns (e.g., columns 246a), rows (e.g., rows 246b), and/or any other properties.

The table A metadata 230 may also, or instead, include one or more table permissions 250 that may limit access to the table A based on one or more permissions. The table permissions 250 may be generally applicable to all access to the table A and/or may be further granularly applied. For instance, the table permissions 250 may include one or more role permissions 252 that may limit access to the data in table A based on permissions associated with a role assigned to a user attempting to access such data. The role permissions 252 may even more granularly limit access to the data of the table A based on one or more columns 252a (“column role permission”) and/or one or more rows 252b (“row role permission”) for a particular role assigned to a user attempting to access such data. For instance, such filters may limit or block access for a particular role (specified in the role permissions 252) to a set of one or more columns (specified in the columns 252a) and a set of one or more rows (specified in the rows 252b).

The table permissions 250 may also, or instead, include one or more user permissions 254 that may limit access to the data in table A based on permissions associated with one or more particular users attempting to access such data. The user permissions 254 may even more granularly limit access to the data of the table A based on one or more columns 254a (“column user permission”) and/or one or more rows 254b (“row user permission”) for particular users attempting to access such data. For instance, such filters may limit or block access for a particular user (specified in the user permissions 254) to a set of one or more columns (specified in the columns 254a) and a set of one or more rows (specified in the rows 254b).

Any other criteria may be used as a basis for table permissions, represented as other permissions 256, and any such permissions may further granularly limit the data that may be extracted from the table A based on columns (e.g., columns 256a), rows (e.g., rows 256b), and/or any other properties.

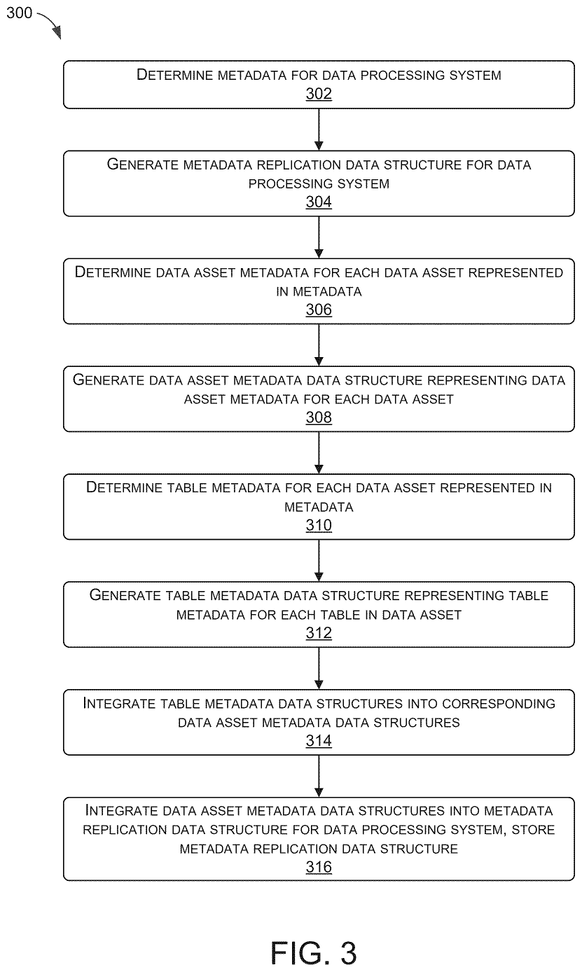

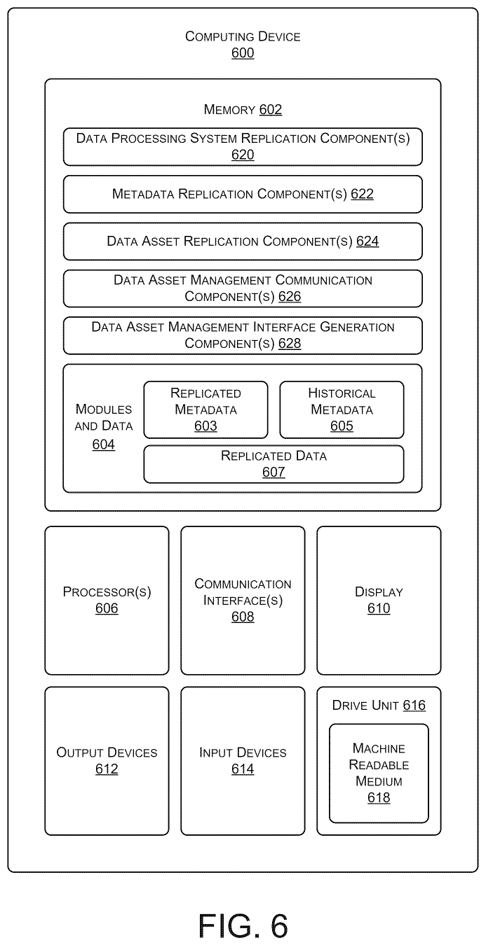

FIG. 3 is a flow diagram of an example process 300 for generating data asset metadata structures in a full spectrum metadata replication and restoration system. In examples, one or more operations of the process 300 may be implemented by a data asset management system and/or a metadata processing system, such as by using one or more of the components and systems illustrated in FIG. 1 and described above and/or by using one or more of the components and systems illustrated in FIG. 6 and described below. For example, one or more such components and systems can include those associated with the metadata processing systems 132 and 152 illustrated in FIG. 1. One or more such components and systems can also, or instead, include those associated with the computing device 600 illustrated in FIG. 6. In other examples, one or more operations of the process 300 may be performed by a combination of components described in regard to these systems and/or other systems. However, the process 300 is not limited to being performed by such components and systems, and the components and systems described herein are not limited to performing the operations of the process 300.

At operation 302, metadata for a data processing system (e.g., an existing, configured, and/or operating data processing system) may be determined. This may be accessing and retrieving metadata stored at the data processing system (e.g., metadata 118, metadata 128). Alternatively or additionally, the operation may be an active step, where various operations are performed to evaluate the individual data assets within the data processing system and determine the assets' configurations and interrelationship (e.g., “crawl” the data processing system).

Using this metadata, at operation 304, the system may generate a metadata replication data structure for the data processing system. For example, the system may generate a data structure similar to that represented in FIG. 2. This data structure may initially be unpopulated or only populated with general data processing system metadata.

At operation 306, the system may determine data asset metadata for each data asset represented in the metadata determined at the operation 302. This may be general data asset metadata applicable to the data asset as a whole, such as a type of data asset, location, management type, etc. (e.g., metadata 290-296 of FIG. 2).

At operation 308, the system may generate a data asset data structure (e.g., as shown in FIG. 2) for each data asset determined in the metadata determined at operation 302. In generating these data structures, the system may include the data asset metadata for each corresponding data asset as determined at operation 306.

At operation 310, the system may determine table metadata for each data asset represented in the metadata determined at the operation 302 that supports tables. This may include determining any table-specific metadata and other information (e.g., as shown in metadata 230 of FIG. 2; see also FIG. 3 and associated description).

At operation 312, the system may generate a table metadata data structure (e.g., as shown in FIG. 2) for each table in each data asset that supports tables determined in the metadata determined at operation 302. In generating these data structures, the system may include the table metadata for each corresponding table as determined at operation 310.

At operation 314, the system may integrate the table metadata data structures into the data asset metadata data structure for the associated data asset.

At operation 316, the system may integrate the data asset metadata data structures into the metadata replication data structure generated at operation 304 for the data processing system. This resulting metadata may be stored for use in replication operations as described herein.

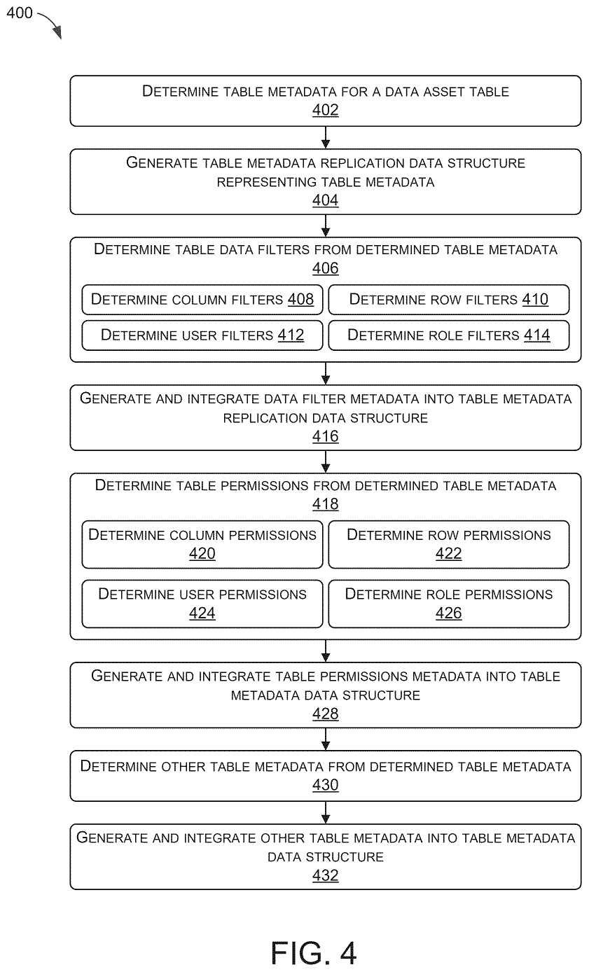

FIG. 4 is a flow diagram of an example process 400 for generating database table metadata structures in a full spectrum metadata replication and restoration system. In examples, one or more operations of the process 400 may be implemented by a data asset management system and/or a metadata processing system, such as by using one or more of the components and systems illustrated in FIG. 1 and described above and/or by using one or more of the components and systems illustrated in FIG. 6 and described below. For example, one or more such components and systems can include those associated with the metadata processing systems 132 and 152 illustrated in FIG. 1. One or more such components and systems can also, or instead, include those associated with the computing device 600 illustrated in FIG. 6. In other examples, one or more operations of the process 400 may be performed by a combination of components described in regard to these systems and/or other systems. However, the process 400 is not limited to being performed by such components and systems, and the components and systems described herein are not limited to performing the operations of the process 400.

At operation 402, table metadata for a table in a data processing system (e.g., an existing, configured, and/or operating data processing system) may be determined. This may be determined by accessing and retrieving metadata stored at the data processing system (e.g., metadata 118, metadata 128). The metadata specific to a table associated with a data asset may then be extracted from the determined data processing system metadata. Alternatively or additionally, the operation 402 may be an active step, where various operations are performed to evaluate the individual data assets within the data processing system and determine the assets' configurations and interrelationship (e.g., “crawl” the data processing system), including the table configurations and operations, to determine table metadata for a table.

Using this metadata, at operation 404, the system may generate a table metadata replication data structure for the table. For example, the system may generate a data structure similar to the data structure for the table A metadata 230 represented in FIG. 2. This data structure may initially be unpopulated or only populated with general table metadata.

At operation 406, the system may determine table data filters and/or table data filter metadata represented in the table metadata determined at the operation 402. This may include determining data filters applicable to the entire table as well as determining, if applicable, table column data filters 408 (e.g., 242a, 244a, 246a of FIG. 2), table row data filters 410 (e.g., 242b, 244b, 246b of FIG. 2), table user data filters 412 (e.g., 244 of FIG. 2), table role data filters 414 (e.g., 242 of FIG. 2), and/or any combination thereof.

At operation 416, the system may generate table data filter metadata based on table data filters determined at operation 406 and integrate the table data filter metadata into the table metadata replication data structure generated at operation 404.

At operation 418, the system may determine table permissions and/or table permissions metadata represented in the table metadata determined at the operation 402. This may include determining permissions applicable to the entire table as well as determining, if applicable, table column permissions 420 (e.g., 252a, 254a, 256a of FIG. 2), table row permissions 422 (e.g., 252b, 254b, 256b of FIG. 2), table user permissions 424 (e.g., 254 of FIG. 2), table role permissions 426 (e.g., 252 of FIG. 2), and/or any combination thereof.

At operation 428, the system may generate table permissions metadata based on permissions determined at operation 418 and integrate the table permissions metadata into the table metadata replication data structure generated at operation 404.

At operation 430, the system may determine any other (e.g., remaining) table metadata from the table metadata determined at operation 402.

At operation 432, the system may integrate the other table metadata into the table metadata replication data structure generated at operation 404 for the table. This resulting metadata may be stored for use in replication operations as described herein. Note that the operations of the process 400 may be performed for a database table associated with a data asset, any (e.g., all) tables associated with a data asset, for all tables in all data assets, and/or for any subset of data assets in a data processing system.

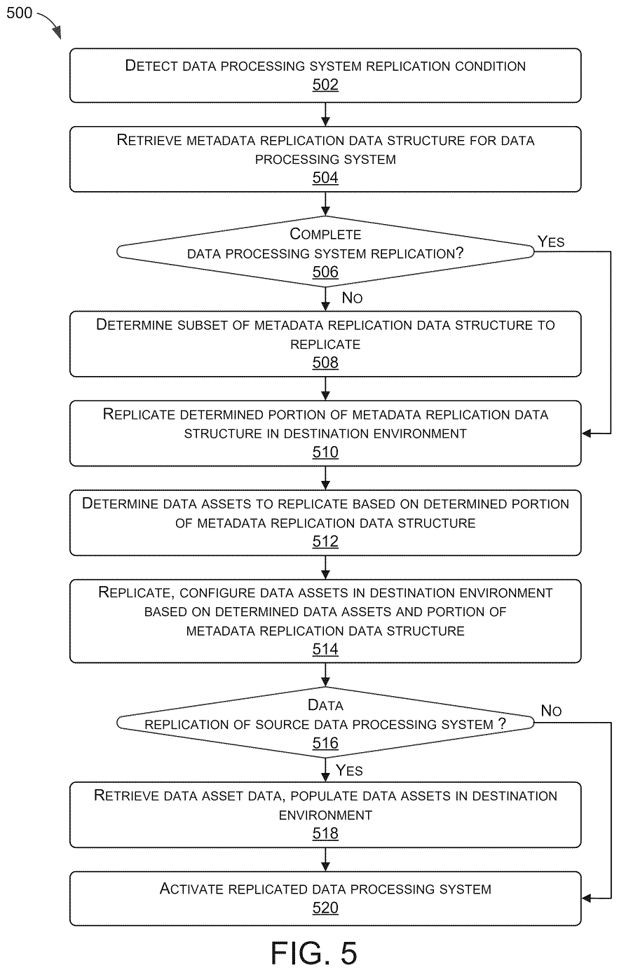

FIG. 5 is a flow diagram of an example process 500 for replicating a data processing system in a full spectrum metadata replication and restoration system. In examples, one or more operations of the process 500 may be implemented by a data asset management system and/or a metadata processing system, such as by using one or more of the components and systems illustrated in FIG. 1 and described above and/or by using one or more of the components and systems illustrated in FIG. 6 and described below. For example, one or more such components and systems can include those associated with the metadata processing systems 132 and 152 illustrated in FIG. 1. One or more such components and systems can also, or instead, include those associated with the computing device 600 illustrated in FIG. 6. In other examples, one or more operations of the process 500 may be performed by a combination of components described in regard to these systems and/or other systems. However, the process 500 is not limited to being performed by such components and systems, and the components and systems described herein are not limited to performing the operations of the process 500.

At operation 502, the system may detect a replication condition for a particular data processing system. This condition, and the detection thereof, may take any suitable form. In examples, a user may activate a control (e.g., controls 177, 178 of FIG. 1) that may generate instructions that cause the system to initiate replication operations. These instructions may include replication parameters, such as source and destination data processing systems, extent of replication, timing of replication, and the like. In other examples, a condition may be detected, and responsive initiation of replication operations may take place without user involvement. For example, a data processing system outage may be detected, and in response, a full replication of the data processing system may be initiated (e.g., at a new platform or location). In another example, the latency of network communications with a data processing system may exceed a threshold (e.g., as detected by periodic probing or other testing communications) and, in response, a full replication of the data processing system may be initiated (e.g., at a new platform or location). Other conditions and/or circumstances that cause the initiation of a replication process are contemplated as within the scope of the instant disclosure. Any such condition may be associated with one or more replication parameters that may be used in the replication process as described herein. Such parameters may be preconfigured for particular conditions at the system and/or provided with instructions accompanying or otherwise associated with the detected condition.

At operation 504 in response to detecting a replication condition at operation 502, the system may retrieve metadata replication data structure (such as shown in FIG. 2) for the associated data processing system. For example, this metadata replication data structure may be retrieved from a metadata processing system such as metadata processing system 132 or metadata processing system 152 of FIG. 1.

At operation 506, the system may determine, based on replication parameters, whether the replication to be performed is a “complete” replication or not. As used herein, a “complete” replication is a replication of the entire architecture of a data processing system, including the data assets and the configurations and interconnections represented by metadata.

If a replication is not complete, at operation 508, the system may determine from the replication parameters the particular portions of the data processing system to be replicated. For example, the replication parameters may indicate a subset of the data assets in a data processing system or even one or more tables in a data asset in a data processing system. Any level of granularity may be specified by the replication parameters. Based on the determined portions of the data processing system to be replicated, the system may determine the subset of the metadata retrieved at 504 that is to be replicated.

If the replication is complete, the process may proceed from operation 506 to operation 510.

At operation 510, the system may replicate the determined portion(s) of the metadata replication data structure in a destination environment (e.g., the portion(s) determined at operation 508 if not a complete replication, otherwise all of the metadata replication data structure). The destination environment may be preconfigured at the system and/or received with instructions associated with the detected replication condition. The destination environment may be a platform or other cloud-based provider. The system may replicate the determined portion(s) of the metadata replication data structure by requesting the creation of a metadata data structure that represents the determined portion(s) of the metadata replication data structure at the destination environment (e.g., using communications via an API at the system and/or an API at a computing system of the destination environment).

At operation 512, the system may evaluate the determined portion(s) of the metadata replication data structure to determine the data assets to be replicated at the destination environment. Alternatively or additionally, the system may determine the se data assets based on other information determined for the data processing system.

At operation 514, the system may then replicate the determined data assets at the destination system and configure the data assets based on the determined portion(s) of the metadata replication data structure. For example, the system may configure various tables at data assets indicated by the metadata with the table data filters and/or table permissions as described herein. The system may replicate the determined data assets by requesting creation of the data assets at the destination environment (e.g., using communications via an API at the system and/or an API at a computing system of the destination environment).

At operation 516, the system may determine whether the data stored at the source data processing system is to be replicated. In examples, the replication may be a restoration of operating data in the source data processing system, and therefore the data stored at data assets in the data processing system may also be replicated at the destination system (e.g., from replicated data, such as replicated data 137 and replicated data 157 of FIG. 1). In other examples, the system replication may be intended to create a functionally similar system that will be processing different data.

If the data of the source system is to be replicated, at operation 518, the system may retrieve data asset data from the source system (or from a backup of such data, such as replicated data 137 and replicated data 157 of FIG. 1). The system may then configure this data at the data assets by requesting creation of the data at the data assets at the destination environment (e.g., using communications via an API at the system and/or an API at a computing system of the destination environment).

At operation 520, the system may activate the newly replicated system. Further at this operation, a notification may be transmitted and/or presented to a user (e.g., on a user interface such as interface 176). This notification may include a status (e.g., success, failure, errors, etc.) for any portion of the process 500.

FIG. 6 shows an example system architecture for a computing device 600 that may be implemented as (e.g., part of) any of the systems and devices described herein and/or may perform any of the operations and processes described herein. For example, the computing device 600 may represent any of the systems, devices, and components illustrated in FIG. 1 and./or configured to process data structures such as those illustrated in FIG. 2. The computing device 600 may also represent any system configured to implement any of the operations described in regard to FIGS. 3-5 and/or any other operation described herein. The computing device 600 may be a server, computer, mobile device (e.g., smartphone, smartwatch, laptop), or any other type of computing device that may execute any of the operations described herein. In some examples, operations as described herein may be distributed among and/or executed by multiple computing devices 600.

A computing device 600 can include memory 602. In various examples, the memory 602 can include system memory, which may be volatile (such as RAM), non-volatile (such as ROM, flash memory, etc.), or some combination of the two. The memory 602 may further include non-transitory computer-readable media, such as volatile and nonvolatile, removable and non-removable media implemented in any method or technology for storage of information, such as computer-readable instructions, data structures, program modules, or other data. System memory, removable storage, and non-removable storage are all examples of non-transitory computer-readable media.

Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by one or more computing devices 600. Any such non-transitory computer-readable media may be part of the computing devices 600.

The memory 602 may include modules and data 604 needed to perform operations as described herein by one or more computing devices 600. Included with such modules and data 604 and/or also stored in the memory 602 may be one or more data processing system replication components 620, one or more metadata replication components 622, one or more data asset replication components 624, one or more data asset management communication components 626, and/or one or more data asset management interface generation components 628. The data processing system replication component(s) 620 may perform any one or more of the operations related to determining, managing, storing, responding to, and/or performing any data processing system replication operations as described herein (e.g., as described for data processing system replication systems 131 and 151 illustrated in FIG. 1). The metadata replication component(s) 622 may perform any one or more of the operations related to determining, managing, storing, responding to, and/or performing any metadata replication operations as described herein (e.g., as described for metadata replication components 133 and 153 illustrated in FIG. 1). The data asset replication component(s) 624 may perform any one or more of the operations related to determining, generating, and/or performing any data asset data replication operations as described herein (e.g., as described for data asset backup systems 136 and 156 illustrated in FIG. 1). The data asset management communication component(s) 626 may perform any one or more of the operations related to generating, transmitting and/or providing any communications data as described herein (e.g., as described for data asset management communication component 158 illustrated in FIG. 1). The data asset management interface generation component(s) 628 may perform any one or more of the operations related to generating, transmitting and/or providing any interface data and/or instructions as described herein (e.g., as described for data asset management interface generation component 159 illustrated in FIG. 1).

Further included with the modules and data 604 and/or also stored in the memory 602 may be replicated metadata 603 that may substantially correspond to any one or more of the replicated metadata 134 and/or replicated metadata 154 illustrated in FIG. 1. Also included with the modules and data 604 and/or also stored in the memory 602 may be historical metadata 605 that may substantially correspond to any one or more of the historical metadata 135 and/or historical metadata 155 illustrated in FIG. 1. Also included with the modules and data 604 and/or also stored in the memory 602 may be replicated data 607 that may substantially correspond to any one or more of the replicated data 137 and/or replicated data 157 illustrated in FIG. 1.

One or more computing devices 600 may also have processor(s) 606, communication interface(s) 608, display(s) 610, output device(s) 612, input device(s) 614, and/or drive unit(s) 616 that may include one or more machine-readable media 618.

In various examples, the processor(s) 606 can be a central processing unit (CPU), a graphics processing unit (GPU), both a CPU and a GPU, or any other type of processing unit. Each of the one or more processor(s) 606 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 606 may also be responsible for executing computer applications stored in the memory 602, which can be associated with common types of volatile (RAM) and/or nonvolatile (ROM) memory.

The communication interfaces 608 may include transceivers, modems, interfaces, antennas, telephone connections, and/or other components that can transmit and/or receive data over networks, telephone lines, or other connections.

The display(s) 610 can be any one or more of a liquid crystal display or any other type of display commonly used in computing devices. For example, the display(s) 610 may include a touch-sensitive display screen that may also act as an input device or keypad, such as for providing a soft-key keyboard, navigation buttons, and/or any other type of input.

The output device(s) 612 may include any sort of output devices known in the art, such as the display(s) 610, one or more speakers, a vibrating mechanism, and/or a tactile feedback mechanism. Output devices 612 may also include one or more ports for one or more peripheral devices, such as headphones, peripheral speakers, and/or a peripheral display.

The input device(s) 614 may include any sort of input devices known in the art. For example, input device(s) 614 may include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine-readable media 618 of drive unit(s) 616 may store one or more sets of instructions, such as software or firmware, that embody any one or more of the methodologies or functions described herein. The instructions can also reside, completely or at least partially, within the memory 602, processor(s) 606, and/or communication interface(s) 608 during execution thereof by the one or more computing devices 600. The memory 602 and the processor(s) 606 may also constitute machine-readable media 618.

With the techniques described herein, a data processing system may be replicated, in whole or in part, in full metadata granularity. This greatly improves the ease and rapidity of deployment of replacement and/or replicated systems, conserving resources and reducing errors that may introduced using conventional manual alternatives.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. A computer-implemented method of replicating a data processing system using metadata, the computer-implemented method comprising:
detecting, by a processor, a data processing system replication condition;
in response to detecting the data processing system replication condition, determining, by the processor, a metadata replication data structure;
determining, by the processor and based at least in part on the metadata replication data structure, data asset metadata for a first data asset;
determining, by the processor and based at least in part on the data asset metadata, a data asset type of the first data asset;
determining, by the processor and based at least in part on the data asset metadata, table metadata for a first database table associated with the first data asset, the table metadata comprising a table permission associated with one or more of a user or a role;
transmitting, by the processor, to a remote computing system via an application programming interface (API), a request to instantiate a second data asset; and
generating, by the processor, a second database table at the second data asset by:
transmitting, by the processor, to the remote computing system via the API, and based at least in part on the table metadata, a request to generate a second database table at the second data asset; and
transmitting, by the processor, to the remote computing system via the API, and based at least in part on the table metadata, a request to configure the second database table at the second data asset with the table permission.

2. The computer-implemented method of claim 1, wherein:
the table permission comprises a role permission, and
the role permission comprises one or more of a column role permission or a row role permission.

3. The computer-implemented method of claim 1, wherein:
the request to configure the second database table comprises a request to configure the second database table with a table data filter,
the table data filter comprises a user data filter, and
the user data filter comprises one or more of a column user data filter or a row user data filter.

4. The computer-implemented method of claim 1, wherein detecting the data processing system replication condition comprising receiving an instruction from a computing device to initiate a replication of the data processing system.

5. The computer-implemented method of claim 4, wherein the instruction comprises one or more replication parameters comprising one or more of an indication of the remote computing system or a subset of the metadata replication data structure.

6. The computer-implemented method of claim 1, further comprising transmitting, to the remote computing system via the API, a request to configure the second database table at the second data asset with data associated with the first data asset.

7. The computer-implemented method of claim 1, wherein the metadata replication data structure comprises historical metadata.

8. A non-transitory computer-readable medium comprising instructions that, when executed by one or more processors, cause the one or more processors to replicate a data processing system using metadata by performing operations comprising:
determining a metadata replication data structure;
determining, based at least in part on the metadata replication data structure, data asset metadata for a first data asset;
determining, based at least in part on the data asset metadata, a data asset type of the first data asset;
determining, based at least in part on the data asset metadata, table metadata for a first database table associated with the first data asset, the table metadata comprising a table permission associated with one or more of a user or a role;
transmitting, to a remote computing system via an application programming interface (API), a request to instantiate a second data asset; and
generating a second database table at the second data asset by transmitting, to the remote computing system, via the API, and based on the table metadata, an executable command to generate the second database table, at the second data asset, configured in accordance with the table permission.

9. The non-transitory computer-readable medium of claim 8, wherein:
the table permission comprises a user permission, and
the user permission comprises one or more of a column user permission or a row user permission.

10. The non-transitory computer-readable medium of claim 8, wherein:
the request to configure the second database table comprises a request to configure the second database table with a table data filter,
the table data filter comprises a role data filter, and
the role data filter comprises one or more of a column role data filter or a row role data filter.

11. The non-transitory computer-readable medium of claim 8, wherein the operations further comprise detecting a data processing system replication condition comprising receiving an instruction from a computing device to initiate a replication of the data processing system.

12. The non-transitory computer-readable medium of claim 11, wherein the instruction comprises one or more replication parameters comprising one or more of an indication of the remote computing system or a subset of the metadata replication data structure.

13. The non-transitory computer-readable medium of claim 12, wherein the subset of the metadata replication data structure comprises data representing the second database table at the second data asset.

14. The non-transitory computer-readable medium of claim 8, wherein the first data asset is configured at a first cloud-based platform and the second data asset is configured at a second cloud-based platform distinct from the first cloud-based platform.

15. A system for replicating a data processing system using metadata, the system comprising:
one or more processors; and
a non-transitory memory storing computer-executable instructions that, when executed, cause the one or more processors to perform operations comprising:
determining a metadata replication data structure;
determining, based at least in part on the metadata replication data structure, data asset metadata for a first data asset;
determining, based at least in part on the data asset metadata, a data asset type of the first data asset;
determining, based at least in part on the data asset metadata, table metadata for a first database table associated with the first data asset, the table metadata comprising a table permission associated with one or more of a user or a role;
transmitting, to a remote computing system via an application programming interface (API), a request to instantiate a second data asset; and
causing the remote computing system to generate a second database table at the second data asset by transmitting, to the remote computing system, via the API, and based on the table metadata, an executable command to generate the second database table, at the second data asset, configured in accordance with the table permission.

16. The system of claim 15, wherein the operations further comprise detecting a data processing system replication condition indicating a failure of the first data asset.

17. The system of claim 16, wherein the operations further comprise receiving an instruction comprising one or more replication parameters comprising one or more of an indication of the remote computing system or a subset of the metadata replication data structure.

18. The system of claim 15, wherein:
the request to configure the second database table comprises a request to configure the second database table with a table data filter,
the table data filter comprises a role data filter, and
the role data filter comprises one or more of a column role data filter or a row role data filter.

19. The system of claim 15, wherein:
the table permission comprises a user permission, and
the user permission comprises one or more of a column user permission or a row user permission.

20. A system for replicating a data processing system using metadata, the system comprising:
means for determining a metadata replication data structure;
means for determining, based at least in part on the metadata replication data structure, data asset metadata for a first data asset;
means for determining, based at least in part on the data asset metadata, a data asset type of the first data asset;
means for determining, based at least in part on the data asset metadata, table metadata for a first database table associated with the first data asset, the table metadata comprising a table permission associated with one or more of a user or a role;
means for transmitting, to a remote computing system via an application programming interface (API), a request to instantiate a second data asset; and
means for generating a second database table at the second data asset by:
transmitting, to the remote computing system via the API and based at least in part on the table metadata, a request to generate a second database table at the second data asset; and
transmitting to the remote computing system via the API and based at least in part on the table metadata, a request to configure the second database table at the second data asset with one or more of a table permission or a table data filter represented in the table metadata.
